(19) United States
(12) Patent Application Publication
(10) Pub. No.: US 2021/0004000 A1
(43) Pub. Date: Jan. 7, 2021

(54) AUTOMATED MAINTENANCE WINDOW PREDICTIONS FOR DATACENTERS

(71) Applicant: VMware, Inc., Palo Alto, CA (US)

(72) Inventors: Naveen Kumar Kalaskar, Fremont, CA (US); Hemant Joshi, San Jose, CA (US); Suma Cherukuri, Milpitas, CA (US)

(21) Appl. No.: 16/458,452

(22) Filed: Jul. 1, 2019

(51) Int. Cl. G05B 23/02; G06F 8/65; G06F 9/455

(52) U.S. Cl. CPC G05B 23/0283; G06F 8/65; G06F 9/45558; G06F 9/45545; G05B 23/0227

(57) ABSTRACT

Disclosed are various embodiments for automating the prediction of maintenance windows in datacenter environments. A user input can be received specifying a start time for a maintenance window. A first amount of time for a host machine to enter a maintenance mode at the start time for the maintenance window is estimated. Then, a second amount of time to update a software component installed on the host machine is estimated. A third amount of time for the host to update a storage cache to match a respective data store can also be estimated. A maintenance window length can then be predicted that comprises a sum of the first amount of time, the second amount of time, and third amount of time. The maintenance window length can then be rendered within a user interface.

### BACKGROUND

Datacenter operators or other cloud computing providers often schedule maintenance on computer servers in advance. These maintenance activities can include updating or upgrading applications currently installed on a server, installing new applications on the server, or other activities. Advance scheduling of maintenance windows offers several benefits, such as allowing for datacenter operators to shift anticipated workloads to other servers or notifying customers of potential service outages or performance decreases that may occur during the maintenance window. When maintenance windows are scheduled for a proper amount of time, all of the maintenance activities can be performed with minimal interruptions to customers or clients.

However, when maintenance windows are poorly scheduled, a datacenter can experience performance degradations that impact client applications or services. For example, if a maintenance window is too short, then servers that were expected to be available for processing client requests or customer loads may be unavailable. This can negatively impact capacity planning for the datacenter. Similarly, if a maintenance window is too long, then servers which could be used for processing client requests or customer loads are unavailable to do so.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of an example of a networked environment according to various embodiments of the present disclosure.

FIG. 2 is an example of a flowchart illustrating functionality implemented by various embodiments of the present disclosure.

FIG. 3 is an example of a user interface rendered by components of the networked environment according to various embodiments of the present disclosure.

### DETAILED DESCRIPTION

Disclosed are various approaches for automatically predicting maintenance window lengths for individual computers, such as servers in a datacenter. Maintenance window predictions can be made by analyzing current or historic resource utilization of the individual computers in conjunction with computing resources (e.g., processor resources, memory resources, network resources, etc.) available to the individual computers and the type of maintenance being performed using various machine learning approaches. As a result, an accurate estimate for the maintenance window can be predicted.

Accurately predicting a length of time required to perform maintenance has a number of benefits to datacenter operators, hosted service providers, cloud computing providers, and in-house information technology (IT) departments. For example, when a server has to have software updates applied, it is usually unavailable to service customer or client requests while the software update is being applied. If the server is scheduled for maintenance for a longer period of time than is actually required, the server may be wasting time that could be used hosting applications, virtual machines, or servicing client requests for files or data. Moreover, the operator of the server may have excess capacity unnecessarily scheduled to handle the workload of the server while the server is being upgraded or updated. Likewise, if an insufficient maintenance window is scheduled, the operator of the server may not have sufficient capacity scheduled to handle the workload of the server at the end of the maintenance window because the operator of the server may have assumed that server would be available when the server is still unavailable.

The maintenance process itself can also be time-consuming. For example, some software updates are quite substantial in size and can take a long time to apply. In addition, the process of migrating the workload from a server prior to performing maintenance can be a time-consuming process. For example, guest virtual machines (VMs) hosted by a server may need to be migrated to another server while still operating. Such live migrations can consume significant resources and take significant amounts of time depending on the amount network bandwidth available to the host, how active individual virtual machines are (e.g., due to the kinds of workloads the virtual machines are executing), and how much spare processor capacity is available to migrate the guest virtual machines to another host server. Accordingly, the amount of time required to prepare a server for an update may vary based on the date, day of the week, or time of day that the operations are performed. Accurately predicting the amount of time required to prepare a server for maintenance (e.g., shifting guest VMs or hosted applications to another server) and perform the maintenance operations (e.g., update an operating system or software application installed on the server) is therefore important to minimize the impact on services, applications, or virtual machines hosted by the server.

To address these problems, various implementations of the present disclosure utilize machine learning approaches to estimate how long of a maintenance window will be required to perform maintenance on a server. The estimates can be based on historic data regarding resource utilization of a server or similar servers, data regarding current hardware capabilities of the server or similar servers, and historic data regarding the time it has taken similar servers or similar servers running similar workloads to perform the same or similar maintenance operations. In the following discussion, a more detailed general description of the system and its components is provided, followed by a discussion of the operation of the same.

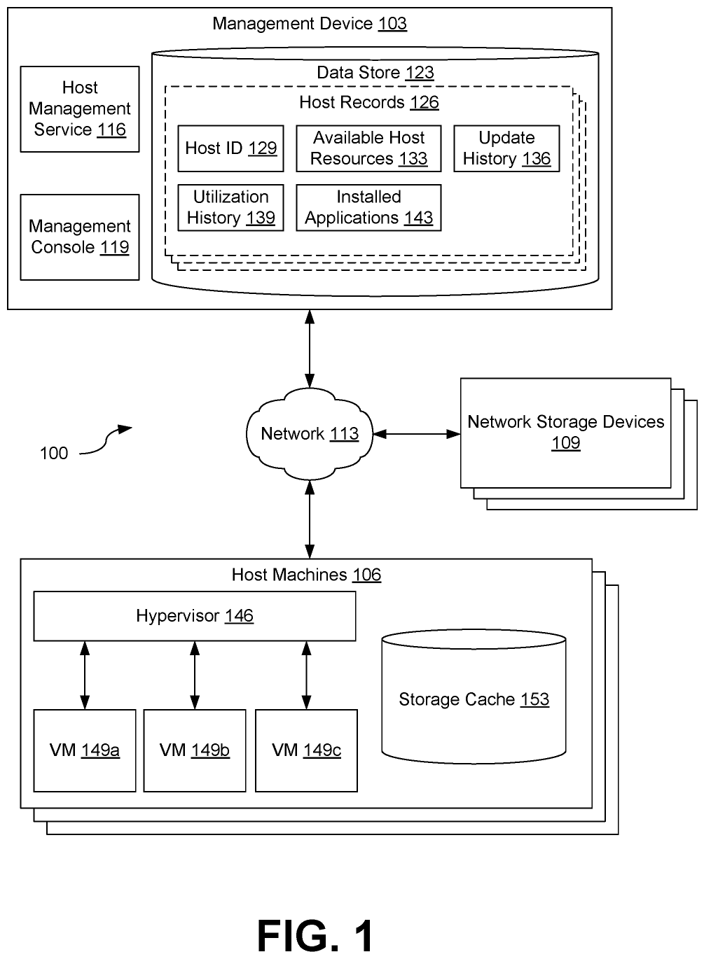

FIG. 1 depicts a networked environment 100 according to various embodiments. The networked environment 100 includes a management device 103, one or more host machines 106, and one or more network storage devices 109, which are in data communication with each other via a network 113. The network 113 can include wide area networks (WANs) and local area networks (LANs). These networks 113 can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 113 can also include a combination of two or more networks 113. Examples of networks 113 can include the Internet, intranets, extranets, virtual private networks (VPNs), and similar networks.

The management device 103 can include a server computer or any other system providing computing capability. In some instances, however, the management device 103 can be representative of a plurality of computing devices used in a distributed computing arrangement, such as a server bank, computer bank, or combination of multiple server banks or computer banks. When using a plurality of computing devices in a distributed computing arrangement, individual management devices 103 may be located in a single installation or may be distributed across multiple installations.

The management device 103 can be configured to execute various applications or components to manage the operation of the host machines 106 or the network storage devices 109. For example, the management device 103 can be configured to execute a host management service 116, a management console 119, and other applications.

The host management service 116 can perform various functions related to the operation of the devices in the networked environment 100. For example, the host management service 116 can collect data from the host machines 106 or network storage devices 109 in data communication with the management device 103. Likewise, the host management service 116 can configure host machines 106 or network storage devices 109. Similarly, the host management service 116 can also be executed to send commands to host machines 106 or network storage devices 109 to perform specified actions. Configuration may be performed, or commands may be sent, in response to user input provided through the management console 119. An example of a host management service 116 includes VMWare's Lifecycle Manager for VMWare's Cloud Foundation®.

The management console 119 can provide an administrative interface for configuring the operation of individual components in the networked environment 100. For instance, the management console 119 can provide an administrative interface for the host management service 116. As an example, the management console 119 may provide a user interface to allow an administrative user to request a predicted amount of time for a maintenance window that would begin at a user specified time. Accordingly, the management console 113 can correspond to a web page or a web application provided by a web server hosted in the management device 103 in some implementations. In other implementations, however, the management console 119 can be implemented as a dedicated or standalone application.

Also, various data can be stored in a data store 123 that is accessible to the management device 103. The data store 123 is representative of a plurality of data stores 123, which can include relational databases, object-oriented databases, hierarchical databases, hash tables or similar key-value data stores, as well as other data storage applications or data structures. The data stored in the data store 123 is associated with the operation of the various applications or functional entities described below. This data can include host records 126, and potentially other data.

A host record 126 can represent an entry in the data store 123 for a respective host machine 106. The host record 126 can include data collected from or reported by the respective host machine 106 as well as data about the host machine 106 itself. For example, a host record 126 can include a host identifier 129, a list of available host resources 133, an update history 136, a utilization history 139, a list of installed applications 143, and potentially other data.

The host identifier 129 can represent an identifier that uniquely identifies a host machine 106 with respect to other host machines 106. Examples of host identifiers 129 can include serial numbers, media access control (MAC) addresses of network interfaces on the host machine 106, and machine names assigned to the host machine 106.

The list of available host resources 133 represents the computing resources available to or installed on the host machine 106. For example, the list of available host resources 133 may include the make and model of the processor(s) installed on the host machine 106, the amount of random access memory (RAM) installed on the host machine 106, the bandwidth of the RAM installed on the host machine 106, the number of network interfaces installed on the host machine 106, the bandwidth available to individual network interfaces installed on the host machine 106, the bandwidth of storage devices on the host machine 106, and similar data.

The update history 136 reflects historical information for updating software or application components of the host machine 106. For each instance that an application was updated or upgraded (e.g., an upgrade of or update to the operating system of the host machine 106, the hypervisor 146, or other application), the length of time that the upgrade or update required, the size or number of any files that were modified, the date and time at which the update or upgrade took place, and potentially other data, can be reported by the host machine 106 to the host management service 116 and recorded as an entry in the update history 136 for the host machine 106. In some implementations, resource states of the host machine 106 at the time that an update or upgrade was performed (e.g., processor consumption, memory consumption, network bandwidth consumption, etc. from workloads of hosted virtual machines 149), may also be included in individual records in the update history 136. These resource states may, for example, be represented by links to individual entries in the utilization history 139 or may be incorporated directly into the individual update records. The update history 136 can be used to estimate the length of time required for future updates or upgrades (e.g., maintenance windows) by using the length of time required for previous updates or upgrades (e.g., historic update times) as a basis, as further described in this application. For example, the update history 136 can be used with a regression model to predict the length of time required for maintenance windows at specific times.

The utilization history 139 can reflect the amount and type of computing resources of the host machine 106 that have been consumed on a historic basis. For example, at periodic intervals (e.g., every minute, every five minutes, every fifteen minutes, every thirty minutes, every hour, etc.), the host machine 106 may report the current resource usage of the host machine 106 to the host management service 116. The resource usage can include statistics such as the number of virtual machines 149 currently hosted by the hypervisor 146 on the host machine 106, the amount of RAM currently committed by the hypervisor 146 for the management of the hosted virtual machines 149, the current size of the storage cache 153, the amount of processor cycles currently consumed by the hypervisor 149 or individual virtual machines 149, and other relevant data.

The list of installed applications 143 includes a list of applications that are currently installed on the host machine 106, including the versions of the applications that are currently installed on the host machine 106. In some implementations, the list of installed applications 143 can also include the current versions of the applications currently installed on the host machine 106. For example, a list of installed applications 143 might indicate that a host machine 106 has version 6.5.4836 of VMWare's ESX hypervisor 146 installed on the host machine 106 and, in some implementations, also note that the current version of VMWare's ESX hypervisor is version 6.5.9877.

The host machines 106 can include a server computer or any other system providing computing capability. Often, multiple host machines 106 may be located in a single installation, such as a datacenter. Likewise, host machines 106 located in multiple data centers may also be in data communication through the network 113 with each other, with the management device 103, or one or more network storage devices 109.

The host machine 106 can provide an operating environment for one or more virtual machines 149, such as virtual machines 149a, 146b, and 146c. Accordingly, a host machine 106 may have a hypervisor 146 installed to manage and coordinate the execution of any virtual machines 149 hosted by the host machine 106. To assist the operation of the hypervisor 146 or the virtual machines 149 hosted by the host machine 106, the host machine 106 may also maintain a storage cache 153.

The hypervisor 146, which may sometimes be referred to as a virtual machine monitor (VMM), is an application or software stack that allows for creating and running virtual machines. Accordingly, a hypervisor 146 can be configured to provide guest operating systems with a virtual operating platform, including virtualized hardware devices or resources, and manage the execution of guest operating systems within a virtual machine execution space provided on the host machine 106 by the hypervisor 146. In some instances, a hypervisor 146 may be configured to run directly on the hardware of the host machine 106 in order to control and manage the hardware resources of the host machine 106 provided to the virtual machines 149 resident on the host machine 106. In other instances, the hypervisor 146 can be implemented as an application executed by an operating system executed by the host machine 106, in which case the virtual machine 149 may run as a thread, task, or process of the hypervisor 146 or operating system. Examples of different types of hypervisors include ORACLE VM SERVER™, MICROSOFT HYPER-V®, VMWARE ESX™ and VMWARE ESXi™, VMWARE WORKSTATION™, VMWARE PLAYER™, and ORACLE VIRTUALBOX®.

The storage cache 153 represents a local storage cache for virtual storage devices provided to the virtual machines 149 hosted by the host machine 106. The virtual storage devices may be provided by one or more network storage devices 109. For example, the network storage devices 109 may implement a storage area network (SAN) or virtual Storage Area Network (vSAN) that provides block-level storage devices to the virtual machines 149. To reduce the latency of reads from or writes to the network storage devices 109, the host machine may provide a storage cache 153 that provides a local copy of frequently accessed data or a temporary queue for storing data to be written to the network storage devices 109. The storage cache 153 can also include a write-ahead log or write log of data written or to be written to the network storage devices 109, which records data written to the storage cache 153 was successfully written to the network storage devices 109.

The network storage devices 109 can include a server computer or any other system providing computing capability. The network storage devices 109 can be configured to provide data storage to other computing devices over the network 113. For example, one or more network storage devices 109 can be arranged into a SAN or vSAN that provides block-level storage to other computing devices using various protocols, such as the Internet Small Computer Systems Interface (iSCSI) protocol, Fibre Channel Protocol (FCP), and other less commonly used protocols. As another example, one or more network storage devices 109 could be configured as network attached storage (NAS) devices that provide file-level storage to other computing devices using various protocols, such as the network file system (NFS), the server message block/common internet file system (SMB/CIFS), or Apple file protocol (AFP).

Although the management device 103, the host machines 106, and the network storage devices 109 are depicted and discussed as separate devices, one or more of these devices could be executed as a virtual machine 149 hosted by another computing device. For example, the functionality provided by the management device 103 could be implemented using a virtual machine 149 executed by a host machine 106 in a data center or similar computing environment. Likewise, one or more network storage devices 109 could be implemented as virtual machines 149 operating on a host machine 106.

Next, a general description of the operation of the various components of the networked environment 100 is provided. Although the following description provides one example of the operation of and the interaction between the various components of the networked environment 100, other operations or interactions may occur in various implementations.

To begin, a host machine 106 is registered with the host management service 116. For example, an administrative user may use the management console 119 to provide information about the host machine 106 to the host management service 116, thereby notifying the host management service 116 of the existence of the host machine 106. For example, the administrative user may provide the host identifier 129 to the host management service 116. In some instances, the administrative user 116 may also configure the host machine 106 to communicate with the host management service 116 using the management console 119.

Upon registration, the host machine 106 can begin to report relevant usage and configuration data to the host management service 116 at periodic intervals. For example, the host machine 106 may report a list of applications currently installed and their versions, the current available host resources 133, the current resource utilization of the host machine 106, and various other data. As updates are performed to various applications installed on the host machine 106, such as the hypervisor 146, data regarding the size of the update, the number of files updated, and the length of time required to perform the update, may also be reported. All of this data can be recorded by the host management service 116 in the data store 123 as part of a respective host record 126. After sufficient amounts of information have been collected over a sufficient period of time, the host management service 116 can use various machine learning techniques to generated estimates for how long it would take to perform a given update to a software component or application installed on the host machine 106, such as the hypervisor 146. As the resource utilization (e.g., processor utilization, memory utilization, network bandwidth utilization, etc.) continues to vary over time, these changes may be taken into account by the host management service 116 to update the appropriate machine learning model.

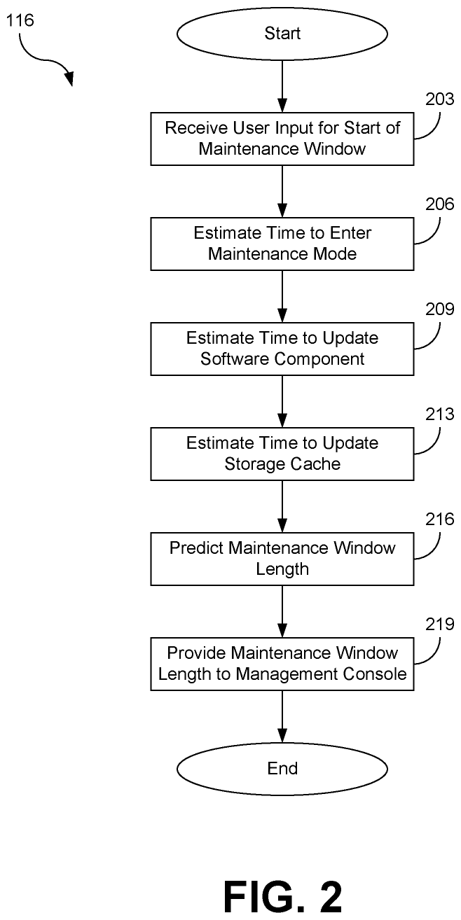

Subsequently, an administrative user can submit a request to the host management service 116 for a prediction or estimate of how long of a maintenance window would be required to perform an update to software (e.g., the hypervisor 146) installed on a specified host machine 106. The request for the estimate can include information such as an anticipated, preferred, or expected date and time for the maintenance window to begin. In response to the request, the host management service 116 can utilize machine learning techniques to estimate how long of a maintenance window would be required based on the utilization history 139 the host machine 106 or similar host machines 106 at similar times, the update history 136 for the same or similar types of updates performed on the host machine 106 or similar host machines 106, and the available host resources 133 of the host machine 106 or similar host machines 106. A more detailed description of how the length of the maintenance window is estimated is provided in the discussion of the flow chart of FIG. 2. The estimate maintenance window can then be rendered within the user interface of the management console 119 for the benefit of the administrative user.

As an illustrative example of the operation of these components, one may consider the use case of updating components of a software defined data center (SDDC), which may include a number of components such as one or more host machines 106 with hypervisors 146 (e.g., VMWare ESX or ESXi) connected through a virtualized or software defined network 109 (e.g., a virtualized network managed by VMWare NSX) and managed by a host management service 116 (e.g., an instance of VMWare Cloud Foundation, including VMWare Lifecycle Manager). In an SDDC environment, one of the more time intensive tasks may include updating or upgrading the hypervisor 146 installed on a host machine 106, as the upgrade to the hypervisor 146 may include multiple steps or stages. These steps can include migrating one or more virtual machines 149 hosted by the hypervisor 146 to another hypervisor 146 on another host machine 106, updating the hypervisor 146 itself, rebooting the host machine 106 of the hypervisor 146, and performing post-update tasks.

Two of the larger contributors to the amount of time spent performing an update to a hypervisor 146 are the migration of virtual machines 149 to another hypervisor 146 and updating or reconciling the storage cache 153. Updating or reconciling the storage cache 153 can include time spent reconciling a virtual storage area network (vSAN) log or a write-ahead log after updating the hypervisor 146 and rebooting the host machine 106. Generally, the time required for a host machine 106 to enter a maintenance mode is predominantly a result of the amount of time required to migrate virtual machines 149 to another host. Likewise, the time required to reboot a host machine 106 after updating software, such as the hypervisor 146, is predominantly a result of the amount of time spent reconciling or updating the storage cache 153.

Migration of individual virtual machines 149 depends on a number of factors. These factors include the amount of memory consumed by a virtual machine 149, the amount of bandwidth available between the current host machine 106 of the virtual machine 149 and the destination host of the virtual machine 149, and the nature of the workload executing on the virtual machine 149. The nature of the workload will influence the dirty page rate of memory pages on the host machine 106 of the virtual machine 149. Accordingly, the amount of time for a host machine 106 to enter maintenance mode may take into account these factors. As an example, equation (1), reproduced below, may be used to estimate this time:

$$Time For Host to Enter Maintenance Mode ≅ ( C * \frac{( vmMem * dpgr )}{vmtnBw} ) + K * numVM \qquad ( 1 )$$

where vmMem represents the amount of memory of the host machine 106 to be migrated to one or more other host machines 106, dpgr represents the dirty page rate for the memory to be migrated, vmtnBw represents the amount of bandwidth available for migration, numVM represents the number of virtual machines 149 to be migrated, and C and K are constants that can be determined using a linear regression analysis of previous times required for the same or similar host machines 106 to enter maintenance mode.

The amount of time required to update or reconcile the storage cache 153 can depend on a number of factors as well. For example, when the host machine 106 may need to update stale entries in the storage cache 153 or clear a log for the storage cache 153. These operations can be CPU intensive, are often unable to be parallelized (e.g., data must be read, processed, and written in order), and therefore can be time-consuming depending on the number of instructions per clock cycle the CPU can execute, the speed of the CPU, and similar factors. As an example, equation (2), reproduced below, may be used to estimate this time:

Time to Update Storage Cache≅M*(p Log Size+l Log Size)|CPUInsCycle (2)

where M represents a constant that can be determined using a regression model based on the amount of time that the same or similar host machines 106 has required to update the storage cache 153 in the past, the p Log Size represents the physical log size for the storage cache 153, the i Log Size represents that logical log size for the storage cache 153, and the CPUInsCycle represents the instruction cycle time for the CPU of the host.

Referring next to FIG. 2, shown is a flowchart that provides one example of the operation of a portion of the host management service 116. As an alternative, the flowchart of FIG. 2 may be viewed as depicting an example of elements of a method implemented in the management device 103. As depicted in the flowchart of FIG. 2, the management component 116 is estimates the length of time required to perform maintenance on a host machine 106 so that an appropriate maintenance window can be scheduled.

Beginning at step 203, the host management service 116 can receive a start date and time for a maintenance window from the management console 119. For example, an administrative user may have selected a proposed start date and time with a user interface provided by the management console 119. The host management service 116 can receive the proposed start date and time from the management console 119 in order to predict required maintenance window length if the maintenance window were to begin at the proposed start date and time.

Then at step 206, the host management service 116 can estimate the amount of time that would be required for a host machine 106 to enter a maintenance mode. The maintenance mode is a state that a host machine 106 can enter when maintenance operations are to be performed. While in maintenance mode, the hypervisor 146 can be prevented from hosting or running virtual machines 149, accepting migrations of virtual machines 149 from other host machines 106, creating new virtual machines 149, or performing other operations. As an example, one could use the previously discussed equation (1) to estimate the time required for the host machine 106 to enter the maintenance mode.

In order to enter the maintenance mode, the hypervisor 146 can take various actions or operations. For example, the hypervisor 146 can migrate any hosted virtual machines 149 to other host machines 106 or power-off any hosted virtual machines 149 in order to prevent updates or upgrades to applications executing on the host machine 106 from impacting or altering the state of the hosted virtual machines 149. For example, a software update to the hypervisor 146 might change or alter the virtualized environment in a manner that could cause a currently executing virtual machine 149 on the host machine 106 to experience a kernel panic or other fatal system error.

Whether a hosted virtual machine 149 is migrated to another host machine 106 or is powered off can be specified by the administrative user or by policy. For example, a default policy may specify that an executing virtual machine 149 is to be migrated to another host machine 106 unless otherwise specified by an administrative user. Accordingly, the host management service 116 can estimate how long the host machine 106 will require to perform actions such as migrating virtual machines 149 to other host machines 106 to determine the amount of time required for a host machine 106 to enter the maintenance mode.

First, the host management service 116 can reference the utilization history 139 to determine the number of virtual machines 149 that are expected to be hosted at the start of the maintenance window or the expected resource utilization of the host machine 106 at the start of the maintenance window. Using various machine learning approaches, the host management service 116 can identify similar time periods in the utilization history 139 of the host machine 106 to determine the number of virtual machines 149 likely to be hosted at the start of the maintenance window and the amount of resources expected to be consumed by the hosted virtual machines 149. As an example, if the maintenance window is specified to begin at midnight on a Friday night, then the host management service 116 can analyze the utilization history 139 of the host machine 106 to determine what the typical load on the host machine 106 is at midnight on a Friday night. As another example, if the maintenance window is specified to occur on a holiday, then the host management service 116 might analyze the utilization history 139 of the host machine 106 to determine what the typical load on the host machine 106 has been in prior years on the specified holiday.

If insufficient data is available for the host machine 106 (e.g., the host machine 106 has been recently deployed), then the host management service 116 may search the host records 126 to identify one or more host records 126 of similar host machines 106. For example, the host management service 116 can search for host records 126 with the same or similar lists of available host resources 133 as the host record 126 for the host machine 106 being modeled. As another example, the host management service 116 can search for host records 126 with the same or similar list of installed applications 143 as the host record 126 for the host machine 106 being modeled. The utilization history 139 of one or more host records 126 of similar host machines 106 can then be used to determine the number of virtual machines 149 that are expected to be hosted at the start of the maintenance window.

Once the number of virtual machines 149 expected to be hosted by the host machine 106 has been determined, the host management service 116 can determine how long it would take for the host machine 106 to enter a maintenance mode. For example, the host management service 116 can calculate how long it would take to perform a live-migration of all of the predicted virtual machines 149 to another host machine 106. The time required for a live-migration of a virtual machine 149 can be impacted by a number of factors, such as the amount of network bandwidth available between the host machine 106 and the destination host machine 106, the amount of RAM currently being consumed by the virtual machine 149, or the dirty page rate of the host machine 106 (writes to RAM by the virtual machine 149 may require individual pages of memory to be transferred more than once). For instance, the time to perform a live-migration of a single virtual machine 149 from a host machine 106 might be predicted by the product of the amount of RAM consumed by the virtual machine 149 and the dirty page rate of the host machine 106, which is then divided by the amount of bandwidth available between the host machine 106 and the destination host machine 106. In some implementations, one or more of these factors can be weighted to reflect relative importance to estimating the time to perform a live-migration when multiple virtual machines 149 are involved.

Next at step 209, the host management service 116 can estimate the amount of time required to update the specified software component (e.g., the time required to update the hypervisor 146). A number of factors can influence the amount time required to update the software component, such as the size of the update, the number of files being updated, modified, or replaced, and the speed of the processor, network connection, and local storage of the host machine 106. Accordingly, the host management service 116 can use various machine learning approaches to analyze the update history 136 of host records 126 for similar host machines 106 to predict how long an update may take. For instance, the host management service 116 can search for host records 129 of host machines 106 where the update history 136 indicates that the update has already been performed. The host management service 116 can then identify in each update history 136 the amount of time spent on the update (e.g., historic update times) to calculate an average time or weighted average time as an estimate for the time required to perform the update on the host machine 106.

Moving on to step 213, the host management service 116 can then estimate the amount of time required to update the storage cache 153 on the host machine 106 to reflect changes in a respective network storage device 109 while the host machine 106 was in maintenance mode. For example, the host management service 116 can reconcile the write-ahead log of the storage cache 153 in response to a post-update reboot. The reconciliation process may involve updating all stale entries in the log and clearing the log at the end of the boot process. This process can be resource intensive. Therefore, the host management service 116 can calculate the estimated amount of time by multiplying the time it takes to execute a CPU instruction cycle by the processor of the host machine 106 by the amount of data that can be processed per CPU instruction cycle. The host management service 116 can then divide the size of the write-ahead log of the storage cache 153 by this value. In some implementations, the final result or individual factors may be weighted to account for the relative importance of the individual factors. As an example, one could use the previously discussed equation (2) to estimate the time required to update the storage cache 153.

Proceeding next to step 216, the host management service 116 can predict the amount of time required for the maintenance window. For example, the host management service 116 can sum the amounts of time previously calculated at steps 206, 209, and 213 to generate an estimated maintenance window length. In some implementations, the estimated maintenance window length can be calculated using a weighted sum to account for potential variability in the prediction. As an illustrative example, the amount of time estimated to enter the maintenance mode can be weighted by a predefined factor (e.g., can be weighted by 5%, 10%, 15%, etc. more or less than predicted) in order to account for potential differences between the estimated amount of time to enter the maintenance mode and the amount of time actually required to enter the maintenance mode if the prediction proves to be inaccurate. This can be done to estimate a range of time for the maintenance window. The predefined factor can be determined using a regression analysis model that analyzes previous maintenance window lengths for the same or similar host machines 106 that had the same or similar workload.

Then at step 219, the host management service 116 can provide the amount of time predicted for the maintenance window to the management console 119. In response to receipt of the predicted amount of time required for the maintenance window, the management console 119 can present this information to the administrative user within a user interface (e.g., a web page).

In implementations where maintenance windows are being estimated for groups of host machines 106 (e.g., a cluster of host machines 106), the process depicted in FIG. 2 can be repeated for each host machine 106 in the cluster or group of host machines 106. In these implementations, the total time, representing a sum of the estimated maintenance window lengths of each individual host machine 106 in the cluster, can also be calculated and provided to the management console 119.

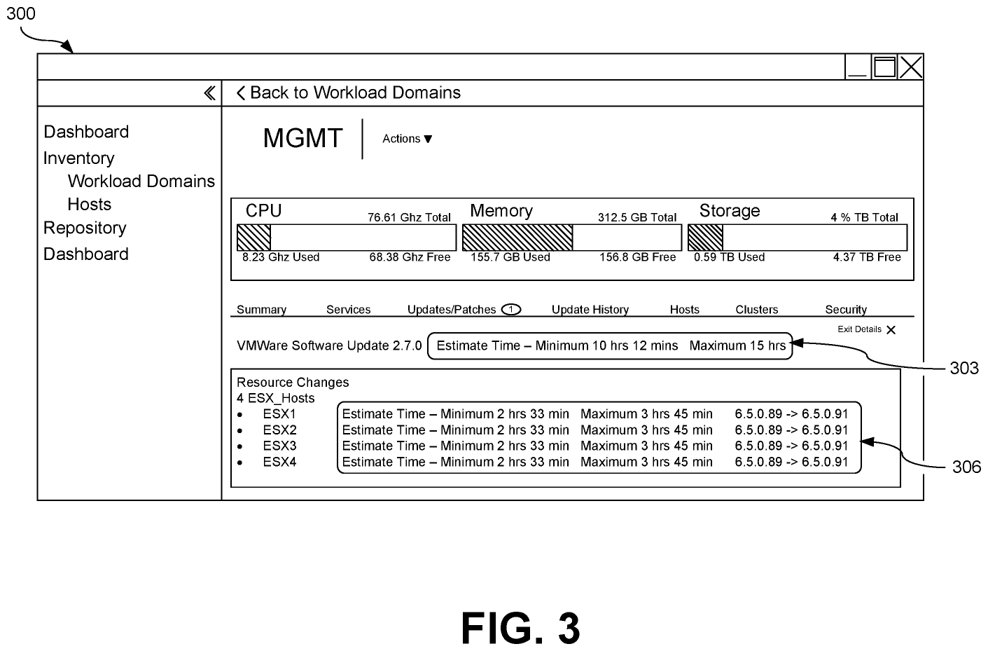

FIG. 3 depicts an example of a user interface 300 generated by the management console 119 in some implementations. As illustrated, an estimated total time 303 to perform an update at a user specified time (e.g., user specified date, day of the way, or date/day and time) is provided. In some implementations, the estimated total time 303 can be presented as a time range. The time range may be the result of using different weighting factors estimate a least and greatest amount of time required to perform an update. In addition, an individual update time 306 is presented for each host machine 106. Using the presented information, an administrative user can then decide whether to schedule the maintenance window at the previously specified time.

A number of software components are stored in the memory and executable by a processor. In this respect, the term “executable” means a program file that is in a form that can ultimately be run by the processor. Examples of executable programs can be, for example, a compiled program that can be translated into machine code in a format that can be loaded into a random access portion of one or more of the memory devices and run by the processor, code that can be expressed in a format such as object code that is capable of being loaded into a random access portion of the one or more memory devices and executed by the processor, or code that can be interpreted by another executable program to generate instructions in a random access portion of the memory devices to be executed by the processor. An executable program can be stored in any portion or component of the memory devices including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

Memory can include both volatile and nonvolatile memory and data storage components. Also, a processor can represent multiple processors and/or multiple processor cores, and the one or more memory devices can represent multiple memories that operate in parallel processing circuits, respectively. Memory devices can also represent a combination of various types of storage devices, such as RAM, mass storage devices, flash memory, or hard disk storage. In such a case, a local interface can be an appropriate network that facilitates communication between any two of the multiple processors or between any processor and any of the memory devices. The local interface can include additional systems designed to coordinate this communication, including, for example, performing load balancing. The processor can be of electrical or of some other available construction.

Although the host management service 116, management console 119, hypervisor 146, other services and functions described can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include discrete logic circuits having logic gates for implementing various logic functions on an application of one or more data signals, application specific integrated circuits (ASICs) having appropriate logic gates, field-programmable gate arrays (FPGAs), or other components.

The flowcharts show an example of the functionality and operation of an implementation of portions of components described. If embodied in software, each block can represent a module, segment, or portion of code that can include program instructions to implement the specified logical function(s). The program instructions can be embodied in the form of source code that can include human-readable statements written in a programming language or machine code that can include numerical instructions recognizable by a suitable execution system such as a processor in a computer system or other system. The machine code can be converted from the source code. If embodied in hardware, each block can represent a circuit or a number of interconnected circuits to implement the specified logical function(s).

Although the flowcharts show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the drawings can be skipped or omitted.

Also, any logic or application described that includes software or code can be embodied in any non-transitory computer-readable medium for use by or in connection with an instruction execution system such as a processor in a computer system or other system. In this sense, the logic can include, for example, statements including instructions and declarations that can be fetched from the computer-readable medium and executed by the instruction execution system. In the context of the present disclosure, a “computer-readable medium” can be any medium that can contain, store, or maintain the logic or application described for use by or in connection with the instruction execution system.

The computer-readable medium can include any one of many physical media, such as magnetic, optical, or semiconductor media. More specific examples of a suitable computer-readable medium include solid-state drives or flash memory. Further, any logic or application described can be implemented and structured in a variety of ways. For example, one or more applications can be implemented as modules or components of a single application. Further, one or more applications described can be executed in shared or separate computing devices or a combination thereof. For example, a plurality of the applications described can execute in the same computing device, or in multiple computing devices.

It is emphasized that the above-described embodiments of the present disclosure are merely possible examples of implementations described for a clear understanding of the principles of the disclosure. Many variations and modifications can be made to the above-described embodiments without departing substantially from the spirit and principles of the disclosure. All such modifications and variations are intended to be included within the scope of this disclosure.

Therefore, the following is claimed:

1. A system for predicting maintenance windows in a software defined data center, comprising:
a computing device comprising a processor and a memory;
machine readable instructions stored in the memory that, when executed by the processor, cause the computing device to at least:
receive a user input specifying a start time for a maintenance window;
estimate a first amount of time for a host machine to enter a maintenance mode at the start time for the maintenance window;
estimate a second amount of time to update a software component installed on the host machine;
estimate a third amount of time for the host to update a storage cache;
predict a maintenance window length that comprises a sum of the first amount of time, the second amount of time, and third amount of time; and
render the maintenance window length within a user interface.

2. The system of claim 1, wherein the machine readable instructions that cause the computing device to estimate the first amount of time for the host machine to enter the maintenance mode further cause the computing device to at least:
estimate a number of virtual machines executing on the host machine at the start time for the maintenance window; and
estimate an amount of time to migrate the number of virtual machines from the host machine to at least one additional host machine.

3. The system of claim 2, wherein the machine readable instructions that cause the computing device to estimate the amount of time to migrate the number of virtual machines from the host machine to at least one additional host machine further cause the computing device to at least:
estimate an amount of memory utilized by the number of virtual machines;
estimate an amount of bandwidth available to migrate the number of virtual machines; and
estimate the amount of time to migrate the number of virtual machines based on the amount of memory utilized by the number of virtual machines and the amount of bandwidth available to migrate the number of virtual machines.

4. The system of claim 1, wherein the machine readable instructions that cause the computing device to estimate the second amount of time to update the software component installed on the host machine further cause the computing device to at least:
identify historic update times for the software component on the host machine or host machines with similar hardware configurations;
calculate an average amount of time to update the software component from the historic update times; and
set the second amount of time to update the software component to the average amount of time to update the software component.

5. The system of claim 1, wherein the machine readable instructions that cause the computing device to estimate the third amount of time for the host to update the storage cache further cause the computing device to at least:
estimate the size of the storage cache at the start time for the maintenance window;
calculate a number of processor cycles for the host machine to update the storage cache based on the size of the storage cache;
identify a processor instruction cycle time for the host machine; and
estimate the third amount of time based on the number of processor cycles and the processor instruction cycle time for the host machine.

6. The system of claim 1, wherein the machine readable instructions that predict the maintenance window length to weight the maintenance window length by a predefined factor to predict a range of time for the maintenance window length.

7. The system of claim 1, wherein the software component is a hypervisor executed by the host machine.

8. A method for predicting maintenance windows in a software defined data center, comprising:
receiving a user input specifying a start time for a maintenance window;
estimating a first amount of time for a host machine to enter a maintenance mode at the start time for the maintenance window;
estimating a second amount of time to update a software component installed on the host machine;
estimating a third amount of time for the host to update a storage cache;
predicting a maintenance window length that comprises a sum of the first amount of time, the second amount of time, and third amount of time; and
rendering the maintenance window length within a user interface.

9. The method of claim 8, wherein estimating the first amount of time for the host machine to enter the maintenance mode further comprises:
estimating a number of virtual machines executing on the host machine at the start time for the maintenance window; and
estimating an amount of time to migrate the number of virtual machines from the host machine to at least one additional host machine.

10. The method of claim 9, wherein estimating the amount of time to migrate the number of virtual machines from the host machine to at least one additional host machine further comprises:
estimating an amount of memory utilized by the number of virtual machines;
estimating an amount of bandwidth available to migrate the number of virtual machines; and
estimating the amount of time to migrate the number of virtual machines based on the amount of memory utilized by the number of virtual machines and the amount of bandwidth available to migrate the number of virtual machines.

11. The method of claim 8, wherein estimating the second amount of time to update the software component installed on the host machine further comprises:
identifying historic update times for the software component on the host machine or host machines with similar hardware configurations;
calculating an average amount of time to update the software component from the historic update times; and
setting the second amount of time to update the software component to the average amount of time to update the software component.

12. The method of claim 8, wherein estimating the third amount of time for the host to update the storage cache further comprises:
estimating the size of the storage cache at the start time for the maintenance window;
calculating a number of processor cycles for the host machine to update the storage cache based on the size of the storage cache;
identifying a processor instruction cycle time for the host machine; and
estimating the third amount of time based on the number of processor cycles and the processor instruction cycle time for the host machine.

13. The method of claim 8, wherein predicting the maintenance window length further comprises weighing the maintenance window length by a predefined factor to predict a range of time for the maintenance window length.

14. The method of claim 8, wherein the software component is a hypervisor executed by the host machine.

15. A non-transitory computer readable medium comprising machine readable instructions for predicting maintenance windows in a software defined data center that, when executed by a processor of a computing device, cause the computing device to at least:
receive a user input specifying a start time for a maintenance window;
estimate a first amount of time for a host machine to enter a maintenance mode at the start time for the maintenance window;
estimate a second amount of time to update a software component installed on the host machine;
estimate a third amount of time for the host to update a storage cache;
predict a maintenance window length that comprises a sum of the first amount of time, the second amount of time, and third amount of time; and
render the maintenance window length within a user interface.

16. The non-transitory, computer readable medium of claim 15, wherein the machine readable instructions that cause the computing device to estimate the first amount of time for the host machine to enter the maintenance mode further cause the computing device to at least:
estimate a number of virtual machines executing on the host machine at the start time for the maintenance window; and
estimate an amount of time to migrate the number of virtual machines from the host machine to at least one additional host machine.

17. The non-transitory, computer readable medium of claim 16, wherein the machine readable instructions that cause the computing device to estimate the amount of time to migrate the number of virtual machines from the host machine to at least one additional host machine further cause the computing device to at least:
estimate an amount of memory utilized by the number of virtual machines;
estimate an amount of bandwidth available to migrate the number of virtual machines; and
estimate the amount of time to migrate the number of virtual machines based on the amount of memory utilized by the number of virtual machines and the amount of bandwidth available to migrate the number of virtual machines.

18. The non-transitory, computer readable medium of claim 15, wherein the machine readable instructions that cause the computing device to estimate the second amount of time to update the software component installed on the host machine further cause the computing device to at least:
identify historic update times for the software component on the host machine or host machines with similar hardware configurations;
calculate an average amount of time to update the software component from the historic update times; and
set the second amount of time to update the software component to the average amount of time to update the software component.

19. The non-transitory, computer readable medium of claim 15, wherein the machine readable instructions that cause the computing device to estimate the third amount of time for the host to update the storage cache further cause the computing device to at least:
estimate the size of the storage cache at the start time for the maintenance window;
calculate a number of processor cycles for the host machine to update the storage cache based on the size of the storage cache;
identify a processor instruction cycle time for the host machine; and
estimate the third amount of time based on the number of processor cycles and the processor instruction cycle time for the host machine.

20. The non-transitory, computer readable medium of claim 15, wherein the software component is a hypervisor executed by the host machine.
